(19) United States
(12) Patent Application Publication
(10) Pub. No.: US 2008/0193335 A1
(43) Pub. Date: Aug. 14, 2008

(54) Electronic Pipetting Device for Aspirating and Dispensing of Set Liquid Volumes

(76) Inventors: Andrzej Czernecki, Warsaw (PL); Wojciech Wyszogrodzki, Warsaw (PL); Piotr Urban, Warsaw (PL); Andrzej Jankowski, Warsaw (PL)

Correspondence Address: Michael Bednarek;Paul, Hastings, Janofsky & Walker, 875 15th Street, N.W., Washington, DC, 20005, US

(21) Appl. No.: 11/660,431

(22) PCT Filed: Sep. 5, 2005
(86) PCT No.: PCT/PL2005/000058

§ 371 Date: Sep. 24, 2007

(30) Foreign Application Priority Data
Sep. 7, 2004 (PL) P369834

(51) Int. Cl. B01L 3/02

(52) U.S. Cl. 422/100

(57) ABSTRACT

An electronic pipetting device for aspirating and dispensing of set liquid volume comprises a handle (1), to the lower part of which a stem assembly (3) is attached, and a control panel (2), whereas the control panel (2) is connected with the handle (1) in such a way that it can rotate with respect to the longitudinal axis of the handle (1) and/or move it upwards and parallel to the longitudinal axis of the handle (1).

### TECHNICAL FIELD

The invention relates to an electronic pipetting device for aspirating and dispensing of set liquid volumes.

### BACKGROUND ART

The pipetting device, known from the U.S Pat. No. 4,054,062, designed for aspirating and dispensing of set liquid volume, comprising an upper part, cylindrically shaped and standing for its handle, and a lower cylindrical part, attached to the said handle. The free end of the lower part is conically shaped for engaging the interior of disposable pipette tips. Moreover, the handle has got a protruding hold for the operator's finger and, in the upper free end, there is a pipetting button and an ejector button which is attached to the cylinder of disposable tips, surrounding the lower part of the said device.

In turn, the portable, electronically programmable automatic pipette, known from the U.S Pat. No. 4,905,526, comprises a linear module of the driving mechanism with a module driving motor, contained in a hand held housing, a control circuit, contained in the driving module housing, for power supply and control of the motor operation, in selective compliance with instructions, either set in advance and/or released by the operator, a shaft, attached to the motor, to provide movements with accurate longitudinal increments in response to the motor drive, a keyboard, connected with the control circuit and located on the housing of the driving module, to be used by the operator to enter commands for the control system, and a display, connected with the control circuit and mounted on the housing of the driving module, close to the keyboard, for a selective display of operation modes and of commands for the pipette, either set in advance or entered by the operator.

Moreover, the pipette has a sampling assembly, attached to the driving module along the shaft, which contains the cylinder, a dosing piston inside the cylinder, a system, which transfers the linear movement of the shaft onto the piston, when the sampling assembly is placed on the driving module, and a sampling chamber in the cylinder, with one side, attached to the piston, and the other with a hole, attached to the tip for aspirating the sampled liquid.

Moreover, a pipetting device with adjustable ejector is known from the U.S. Pat. No. 6,779,412. This pipetting device comprises a body, and an arm which can be moved with respect to the body in a longitudinal direction in order to eject a disposable tip, fixed at the body end, and an ejector button to control the arm movements. In the said pipetting device, the ejector button can be moved with respect to the body in a plane, perpendicular to the longitudinal direction by being able to occupy any position from a continuous range of positions in this plane and by making it possible to control the movement of the arm in said any position. Moreover, the ejector button can rotate with respect to the body around the axis, perpendicular to the longitudinal direction

Also known is the Finnpipett Novus of the Thermo Electron Corporation, USA, comprising a body with a middle handle portion, a lower portion with a stem assembly and a control panel in the upper portion. In its middle portion, the pipette has a protruding and adjustable hold for the operator's finger; the hold can be moved with respect to the body, taking various positions in the plane perpendicular to the body axis.

In the known solutions, there is a problem with the adjustment of setting and control elements of the pipetting device to the size of the operator's palm and to his preferences in operating the said device.

### DISCLOSURE OF INVENTION

One aim of this invention is to provide an electronic pipetting device for aspirating and sampling of set liquid volumes, with a structure forcing simultaneous firm holding of this device and its proper operation by the user.

The next aim of the invention is to provide a pipetting device, comprising a structure, assuring a mobility of the control panel in two degrees of freedom with regards to the handle and such a mutual configuration of pipetting, programming and ejector buttons, as well as of the data display location on the mobile control panel and the handle as to provide the user with the most comfortable for him positioning of the pipetting device components and to enable proper operation of the said device.

The next aim of the invention is to provide a pipetting device, comprising a structure, which assures a stable setting of a previously determined and convenient position of the control panel with regards to the handle during the operation of the said device.

The essential point of the solution, as applied in the said invention, is the application in the electronic pipetting device, comprising a handle, to the lower part of which a piston assembly is attached, and the control panel, of such a connection of the control panel to the handle that the control panel can rotate with respect to the longitudinal axis of the handle and/or protruding from it parallel to the longitudinal axis of the handle.

The said device, following the invention, comprises the advantageous connection of the ejector button and of the holder with the handle, while, with the control panel, the pipetting button is connected, which rotates together with it around the longitudinal axis of the handle, or the ejector button is connected with the handle, while, with the control panel, the holder and the pipetting button are connected, which rotate together with it around the longitudinal axis of the handle.

What is advantageous in the said device, following the invention, is the mechanism for stable setting of the angular position and/or the longitudinal position of the control panel with respect to the handle.

The advantage of the solution, following the invention, is that it provides, in parallel, firm handling of the ergonomically designed handle and proper operation of the said device by the user.

Moreover, an operator, can, in general, arbitrarily move and rotate as well as determine the position of the control panel with respect to the handle to conveniently control the said device via an easy access to the pipetting and programming buttons on the control panel and to the ejector button on the handle with a simultaneous ability to observe the data display on the mobile control panel.

### BRIEF DESCRIPTION OF DRAWINGS

The invention embodiment is presented by way of drawing documentation, in which,

FIG. 1 presents the general view of the electronic pipetting device, following the invention,

FIG. 2—is a top view of the said device,

FIGS. 3 and 4 are top views of the said device with the control panel, rotated with respect to the handle axis in comparison with FIG. 2,

FIG. 5—is a side view of the said device,

FIG. 6—is a side view of the said device with the control panel, extended from the handle, parallel to its longitudinal axis, in comparison with FIG. 5,

FIG. 7—is an enlarged fragment from FIG. 6 with the mechanism. Setting the stable angular and longitudinal position of the control panel with respect to the handle, while

FIG. 8—is detail A from FIG. 7, the same elements of the device having the same numbers on the drawing.

### BEST MODE OF CARRYING OUT THE INVENTION

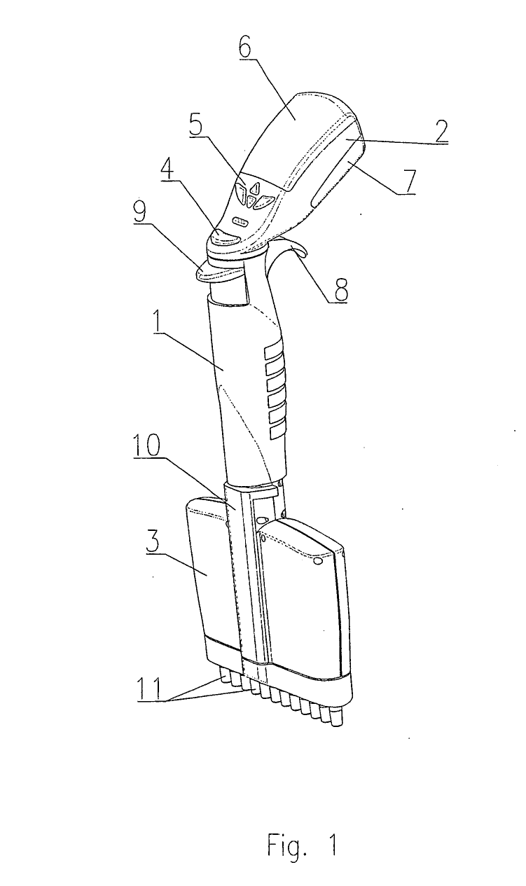

The electronic pipetting device, as presented in the general view in FIG. 1, comprises a generally cylindrical handle 1, to the upper part of which, a control panel 2 is attached, while to its lower part, a detachable stem assembly is attached, where the term ‘detachable stem’ is to be understood as single- or multichannel stem 3.

The control panel 2 is connected with the handle 1 in such a way that it can rotate with respect to the longitudinal axis of the handle 1 and in a plane, perpendicular to it, by angle, set up by the operator of the pipetting device. The control panel 2 comprises a programmed electronic system controlling the operation of the whole pipetting device. The control panel 2 has a pipetting button 4, which rotates together with it around the longitudinal axis of the handle 1 and, in its upper part, a series of programming buttons to enter the device operation parameters into the electronic system, and a display 6 of data, entered to the electronic memory of the device and of data, informing about liquid volumes, aspirated and sampled by the device. Moreover, the control panel 2 has in its lower part a cover 7 of the battery chamber.

In the handle 1, there is—not shown in the drawing—an electromechanical drive system, controlled from the control panel 2 and performing mechanical functions, associated with the drive of the multichannel module 3, attached to the handle 1. In the upper part of the handle 1, the hold 8 is attached to hang the device on a rack or to enable firm and convenient holding of the handle in hand during the pipette operation, as well as the ejector button 9.

The multichannel module 3, controlled by means of a clutch from the drive system of the handle 1, comprises—not show in the drawing—the stem, the sealing assembly and a mobile plunger and an ejector 10 and stems 11 for replaceable containers for liquid. The ejector 10, controlled by the button 9, is to eject the containers for liquid, seated on the stems 11.

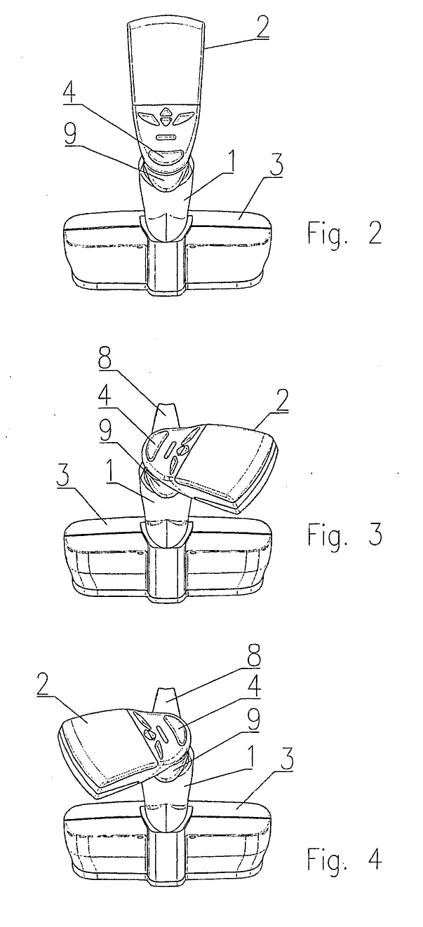

The control panel 2, presented in FIGS. 2, 3 and 4 in the top view, can take a position, as set up by the operator, with respect to the handle 1 in a plane, perpendicular to its longitudinal axis. In FIG. 2, the longitudinal axis of the control panel 2 overlaps with the hold 8 and the button 9 of the ejector 10. In FIGS. 3 and 4, the axis is deflected from the above elements of the said device. It enables a simultaneous firm holding of the handle 1 in hand and such deflection of the control panel 2 with respect to the handle 1 as to conveniently control the device, i.e., manipulate the pipetting button 4, the programming buttons 5 or the ejector button 9, as well as to observe the display 6.

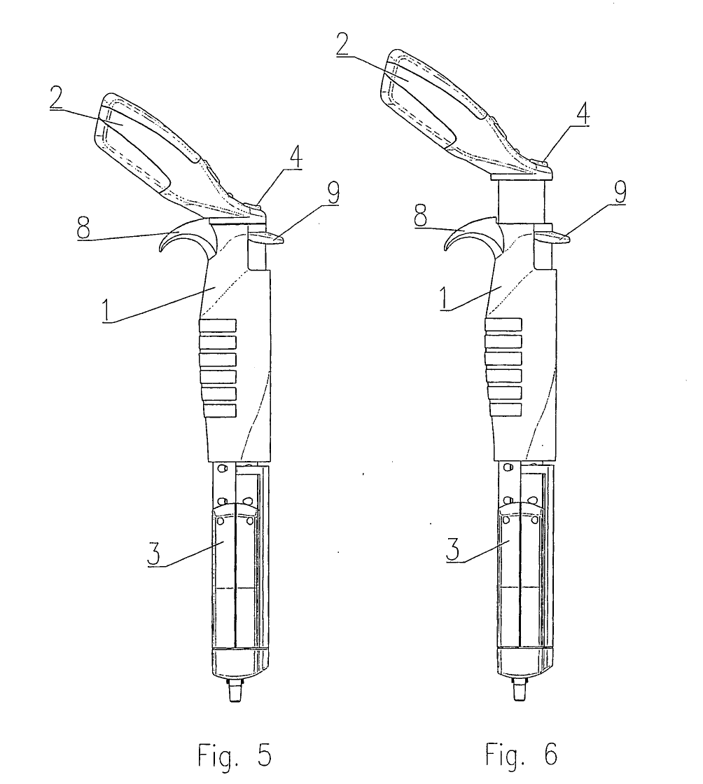

In the side view of the electronic pipetting device, as presented in FIG. 5 from FIG. 1, the control panel 2 is connected with handle 1 in such a way that it can protrude from it upwards, parallel to the longitudinal axis of the handle 1. Such an extension of the control panel 2 is presented in FIG. 6.

In order to provide stable position of the control panel 2 with respect to the handle 1 during the pipetting device operation, following the invention, a mechanism has been applied to determine stable angular and longitudinal position of the control panel 2 with respect to the handle 1.

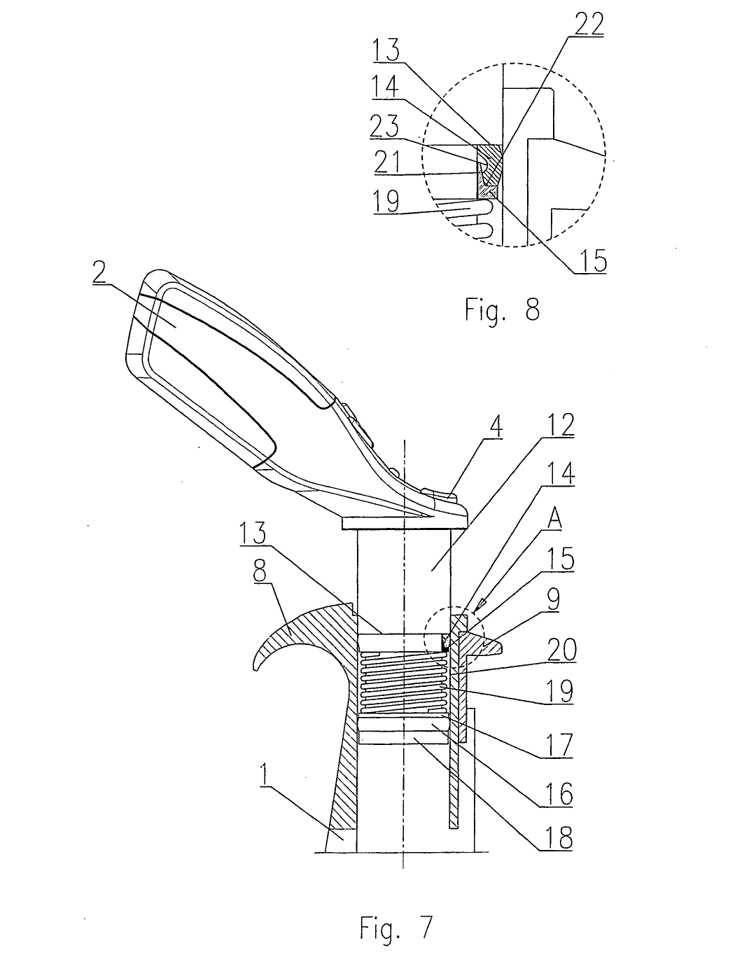

In FIGS. 7 and 8, an example of such a mechanism, determining stable position in the electronic pipetting device, has been presented, following the invention The control panel 2 has an arbor 12 of two diameters, seated in the handle 1, while, on the connection between the larger and the smaller diameter of the arbor 12 of the control panel 2, there is a stopper 13 surface, to which the first spring ring 14 adheres with the first washer 15. In the lower part of the arbor 12, there is the second spring ring 16 with the second washer 17, where the arbor 12 of the control panel 2 ends with a ring 18 for support of the second spring ring. Between the first and the second washer 15, 17 on the arbor 12, there is a pressure spring 11, 19. The handle 1 has an internal race 20, matching the first and the second spring ring 14, 16.

The action of the mechanism, setting stable angular and longitudinal position is as follows. The surface of the stopper 13 and the ring 18 are connected in such a way as to provide constant distance between them. The first and the second spring ring 14, 16, move along the internal race 20, enabling rotational, as well as longitudinal movement of the arbor 12 of the control panel 2 with respect to the internal race 20 of the handle 1. A spring 19, placed between the first and the second washer 15, 17, exerts constant pressure on the first and the second spring ring 14, 16. The washers 15, 17 have a conical collar 21 and a fading face 22, on which the spring ring 14 is seated. The spring rings 14, 16 comprise notches 23, made in such a way that the pressure, exerted by the pressure spring 19, via the washers 15, 17, causes buckling of the profiles of the spring rings 14, 16, resulting—in effect—in an increase of their external diameters. The pressure of the spring rings 14, 16 on the race 20 and on the stopper 13 surface, introduces braking torque between the race 20, being a part of the handle 1, and the stopper 13 surface, being a part of the control panel 2. This is how stable setting of the angular position and stable setting of the longitudinal position of the control panel 2 are obtained with respect to the handle 1. The obtained braking torque is high enough to prevent any incidental change in the position of the control panel 2 with respect to the handle 1, while also small enough, to enable any planned changes in the position of the control panel 2 with respect to the handle 1.

On the basis of the above examples of the invention make, it is possible to provide its different changes, modifications and improvements, while such changes, modifications and improvements are obvious in the light of the idea of the invention and the enclosed patent claims.

1. The electronic pipetting device for aspirating and dispensing of set liquid volume, comprising a handle, to the lower part of which a stem assembly is attached, and a control panel, characterized in that the control panel (2) is connected with the handle (I) in such a way that it can rotate with respect to the longitudinal axis of the handle (1).

2. The electronic pipetting device for aspirating and dispensing of set liquid volumes, comprising a handle, to the lower part of which a stem assembly is attached, and a control panel, characterized in that the control panel (2) is connected with the handle (1) in such a way that it can move parallel to the longitudinal axis of the handle (1).

3. The pipetting device, as claimed in claim 1, characterised in that the control panel (2) is provided with a pipetting button (4), which rotates together with the control panel (2) around the longitudinal axis of the handle (1).

4. The pipetting device, as claimed in claim 1, characterised in that the control panel (2) is provided with a display (6), which rotates together with the control panel (2) around the longitudinal axis of the handle (1).

5. The pipetting device, as claimed in claim 1, characterised in that to the control panel (2) is attached a hold (8), which rotate together with the control panel (2) around the longitudinal axis of the handle (1).

6. The pipetting device, as claimed in claim 1, characterised in that to the handle (1) is attached a hold (8).

7. The pipetting device, as claimed in claim 1, characterised in that to the handle (1) is attached a button (9) of an ejector (10).

8. The pipetting device, as claimed in claim 1, characterized in that it comprises a mechanism for stable setting of the position of the control panel (2) with respect to the handle (1).

9. The pipetting device, as claimed in claim 8, characterized in that the mechanism for stable setting of the position of the control panel (2) with respect to the handle (1) is the mechanism for stable setting of the angular and/or longitudinal position of the control panel (2) with respect to the handle (1) .

10. The device, as claimed in claim 9, characterized in that mechanism for stable setting of the position of the control panel (2) with respect to the handle (1) constitutes a couple of, mating with an internal race (20) of the handle (I), assemblies of a spring ring (14, 16) and a profiled washer (15, 17), which are seated on a stem (12) of the control panel (2) and are separated by a compression spring (19).
